(19) United States
(12) Patent Application Publication
(10) Pub. No.: US 2011/0252252 A1
(43) Pub. Date: Oct. 13, 2011

(54) SYSTEM AND METHOD FOR IDENTIFYING AND REDUCING POWER CONSUMPTION BASED ON AN INACTIVITY PERIOD

(75) Inventors: Bhaskar Ramakrishnan, Wilsonville, OR (US); Graeme Adams, Cambs (GB)

(73) Assignee: Xerox Corporation

(21) Appl. No.: 12/758,626

(22) Filed: Apr. 12, 2010

(51) Int. Cl. G06F 1/00

(52) U.S. Cl. 713/320

(57) ABSTRACT

A system and method for identifying and reducing power consumption in a rendering device based on an inactivity period. Historical data based on a customer usage pattern can be analyzed to detect the inactivity period (e.g., end of day) and to intelligently force the device into a lower energy state. A sleep and low power time can be calculated and a sleep and low power time out period can be reduced to a minimum value based on the inactivity period.

### TECHNICAL FIELD

Embodiments are generally related to rendering devices such as, printers, scanners, multifunction devices, photocopy machines, and the like. Embodiments are also related to power-saving techniques. In addition, embodiments relate to methods for reducing power consumption in rendering devices.

### BACKGROUND OF THE INVENTION

Rendering devices such as printers, scanners, faxes, multifunction devices, copy machines, and so forth, operate at different power consumption levels. Such rendering devices enter a power saver, low-energy consumption mode after a predefined period of time since its last operational mode in order to minimize power usage during idle periods. The power-saving modes reduce the energy consumed by the rendering device. The withdrawal of the device from a power-saving mode, upon entry of a rendering code can cause a user to experience an inconvenient delay before rendering actually commences because the device requires a warm-up period.

A timeout period between the operational mode and the power-saving modes can be determined by a job activation (JA) method or an intelligent ready (IR) method. As utilized the term “timeout” or “timeout period” can refer to, for example, a time or a period (or periods) between events or transitions. The job activation method applies fixed time outs when an activity associated with the rendering device is completed. The intelligent ready method includes two independent mechanisms to control the availability of the rendering device. The first mechanism modifies the timeouts based on current and recent usage with respect to the rendering device. The second mechanism employs a long term historic data to ensure availability of the rendering device when usage is expected.

FIG. 1 illustrates a graph 100 depicting data indicative of power consumption with respect to a rendering device, such as, for example, a printer, a multi-function device, etc. The graph 100 depicted in FIG. 1 generally indicates Intelligent Ready data and job-activated data. Data can be plotted as indicated at data bars 110, 112, 114, 116, 118, and 120. For example, the energy category 110 indicates the energy consumed. Data bar 118, on the other hand indicates a “Sleep Start” category and data bar 116 indicates a “Low Power Start” category representing the number jobs that start from a Low Power state. A job activation bar 130, for example, represents the energy consumed by the rendering device in a job activation setting. Note that as utilized herein the term “low power” and “sleep” refer generally to power-saving modes or states.

The graph 100 is based on the fact that a number of rendering jobs must typically wait for the rendering device to warm up from the low power mode as the device is in the job activated mode rather than an “intelligent” ready mode. Such a wait time decreases the availability of the rendering device with respect to a user (e.g., a customer) and therefore such a wait time should to be minimized. If the rendering device enters and exits a sleep mode several times a day, the life of the majority of the components associated with the rendering device will be significantly reduced.

Prior art power reduction techniques have been implemented. Such techniques, however, are generally unable to detect a period of zero activity and unnecessarily restrain the machine in an “awake” state. Such prior art power reduction approaches can also lead to increased energy consumption because the “intelligent” ready values for the low power and sleep modes are greater than the fixed values.

Based on the foregoing, it is believed that a need exists for an improved system and method for identifying and reducing power consumption in a rendering device based on an inactivity period. A need also exists for an improved method to minimize a wake up time from a sleep state and a low power state, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved system and method for configuring rendering devices, such as printers, scanners, multifunction devices, photocopy machines, and the like.

It is another aspect of the disclosed embodiments to provide for an improved system and method for identifying and reducing power consumption in a rendering device based on an inactivity period.

It is a further aspect of the disclosed embodiments to provide for an improved method for analyzing historical data based on a customer usage pattern to intelligently force the machine into a sleep mode.

The aforementioned aspects and other objectives and advantages can now be achieved as described herein. A system and method for identifying and reducing power consumption in a device (e.g., a rendering device such as a printer, etc) based on an inactivity period is disclosed. Historical data based on a customer usage pattern can be analyzed to detect the inactivity period (e.g., end of day) and to intelligently force the device into a sleep state. A sleep and low power time can be calculated and a sleep and low power time out period can be reduced to a minimum value based on the inactivity period. A long term usage with respect to the device can also be calculated based on the historical data in order to ensure that the device is not in a low power state when usage is expected. The long term usage data can be optimized to minimize the probability of a wake up time from the sleep and low power time. Such an approach permits the device to enter a low energy state sooner and then be awakened prior to an expected activity in order to maximize the energy saving without causing customer dissatisfaction. Thus, the lower power and sleep time outs are reduced to their respective minimum values based on a period of inactivity.

The historical data with respect to usage of the device can be collected and stored in association with a database coupled to the device. The historical usage patterns can be tracked on a daily basis and the device can be forced into the sleep state at the end of day and the impact on the device availability can be minimized if the end of day use varies from day to day. The long term usage can be tracked on daily basis over the preceding weeks (e.g., three weeks). The sleep idle time value and the historical data weighting calculation can be modified in order to predict a wake-up time before an activity is commenced with respect to the device. Such an approach can adjust the power consumption level associated with the device by modifying the timeout algorithms associated with the device to enter or exit the sleep state. Thus, the machine can transition into a sleep state based on historical inactivity data.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graphical representation illustrating power consumption with respect to a rendering device;

FIG. 2 illustrates an example of a rendering device coupled to a data-processing apparatus through a network, in accordance with the disclosed embodiments;

FIG. 3 illustrates a graphical representation of a power reduction system associated with a network of rendering devices, in accordance with the disclosed embodiments;

FIG. 4 illustrates a block diagram of the power reduction system associated with a time out adjustment module, in accordance with the disclosed embodiments;

FIG. 5 illustrates a high level flow chart of operation illustrating logical operation steps of a method for reducing power consumption in the rendering device based on an inactivity period, in accordance with the disclosed embodiments;

FIG. 6 illustrates a table illustrating historical data and the inactivity period associated with the rendering device, in accordance with the disclosed embodiments; and

FIG. 7 illustrates a table illustrating an intelligent ready value, a low-power time, and a sleep time value associated with the rendering device, in accordance with the disclosed embodiments.

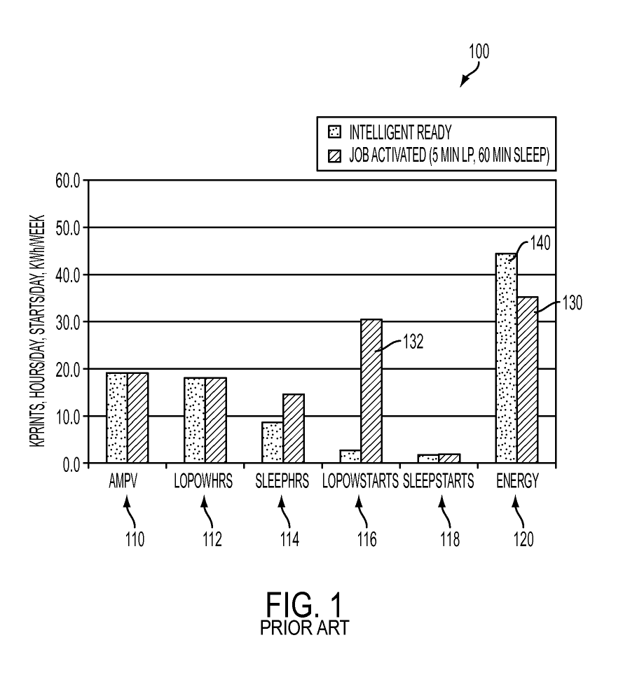

### DETAILED DESCRIPTION

The particular values and configurations discussed in these non-limiting examples can be varied and are cited merely to illustrate at least one embodiment and are not intended to limit the scope thereof.

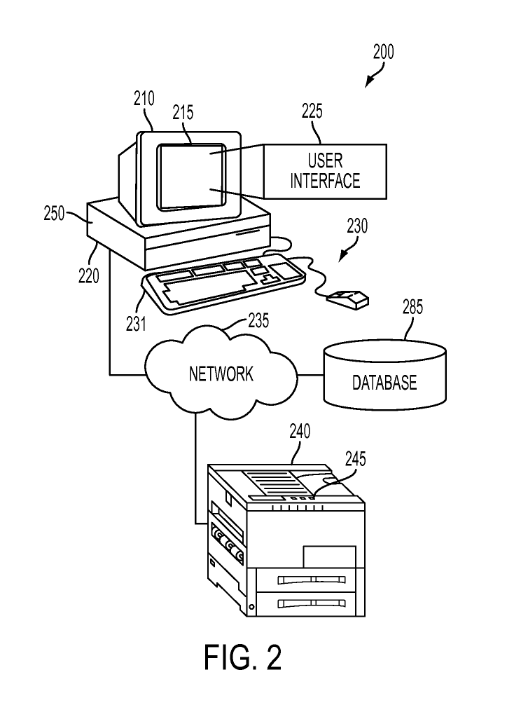

FIG. 2 is provided as an exemplary diagram of data processing environments in which embodiments of the present invention can be implemented. It should be appreciated that FIG. 2 is only exemplary and is not intended to assert or imply any limitation with regard to the environments in which aspects or embodiments of the present invention can be implemented. Many modifications to the depicted environments can be made without departing from the spirit and scope of the present invention.

Referring to FIG. 2, system 200 includes a rendering device 240 that communicates with a data-processing system 210 through a network 235. The data-processing system 210 can be, for example, a personal computer or other computing device, and generally includes a central processor 220, a display device 215, a keyboard 231, and a pointing device 230 (e.g., mouse, track ball, pen device, or the like). Note that in other embodiments, the rendering device 240 may communicate directly with the data-processing system 210, rather than through a network such as, for example, network 235.

Note that as utilized herein, the term rendering device may refer to an apparatus or system such as a printer, scanner, fax machine, copy machine, etc., and/or a combination thereof. Preferably, rendering device 240 is capable of multiple rendering functions such as printing, copying, scanning, faxing, etc. In some embodiments, rendering device 240 can be implemented with a single rendering function such as printing. In other embodiments, rendering device 240 can be configured to provide multiple rendering functions, such as scanning, faxing, printing and copying. Note that the rendering devices 242 and 244 described in greater detail herein are analogous or similar to rendering device 240.

The data-processing system 210 can communicate with the rendering device 240 through, for example, a computer network 235 or other networking configuration. Network 235 may employ any network topology, transmission medium, or network protocol. Network 235 may include connections, such as wire, wireless communication links, or fiber optic cables. The rendering device 240 includes a user interface 245, such as a panel menu. The panel menu can be employed to select features and enter other data in the rendering device 240. Such interfaces may include, for example, touch screens having touch activated keys for navigating through an option menu or the like.

A rendering device driver program can be installed on the data-processing system 210 and can reside on the host device's hard drive 250. The rendering device driver program can be activated through an application interface so that a user may generate a rendering job with the driver for processing by the rendering device 240. The data-processing system 210 also includes a GUI 225 for communicating rendering device features for processing, for example, the rendering job to a user and accepting the user's selection of available rendering device features. The user interface 225 displays information and receives data through device display and/or the keyboard/mouse combination. The interface 225, also serves to display results, whereupon the user may supply additional inputs or terminate a given session. The data-processing system 210 can be, for example, any computing device capable of being integrated within a network, such as a PDA, personal computer, cellular telephone, point-of-sale terminal, server, etc.

Note that the user interface as utilized herein generally refers to a type of environment that represents programs, files, options and so forth by means of graphically displayed icons, menus, and dialog boxes on a screen. The input device of the rendering devices 240, 242 and 244 includes can be a local user interface, such as a touch-screen display or separate keypad and display or a memory fob or the like as discussed above. Alternatively or additionally, the input device can be a wireless port that receives a wireless signal containing constraint data from a portable device. The wireless signal can be an infrared or electromagnetic signal. A system administrator may input constraint data through the local user interface by manipulating the touch screen, keypad, or communicating via wireless messages through the wireless port. The administrator's portable device that communicates wirelessly can be a personal digital assistant (PDA), or the like, as noted above.

The following description is presented with respect to embodiments of the present invention, which can be embodied in the context of a data-processing system 210 and rendering device 240 depicted in FIG. 2. The present invention, however, is not limited to any particular application or any particular environment. Instead, those skilled in the art will find that the system and methods of the present invention can be advantageously applied to a variety of system and application software, including database management systems, word processors, and the like. Moreover, the present invention can be embodied on a variety of different platforms, including Macintosh, UNIX, LINUX, and the like. Therefore, the description of the exemplary embodiments, which follows, is for purposes of illustration and not considered a limitation.

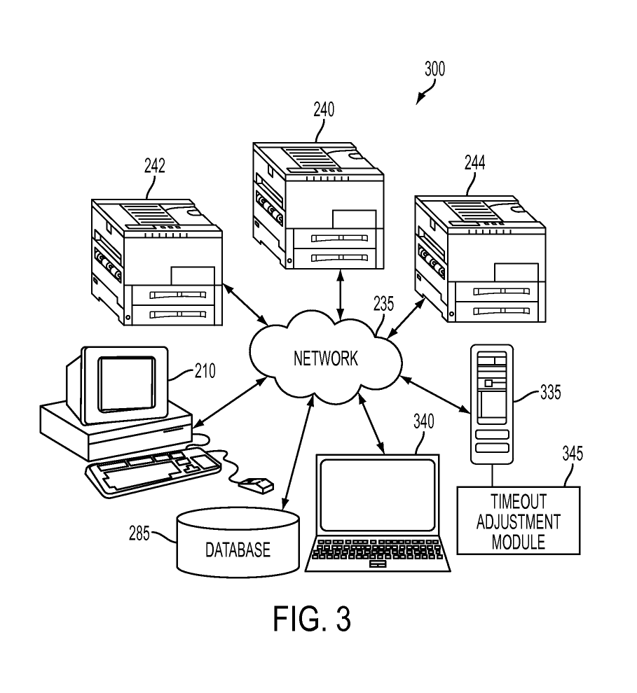

FIG. 3 illustrates a graphical representation of a power reduction system 300 associated with the network 235, in accordance with the disclosed embodiments. Note that in FIGS. 2-7, identical or similar blocks are generally indicated by identical reference numerals. The power reduction system 300 generally includes one or more rendering devices 240, 242 and 244, data-processing system 210, laptops 340 and servers 335. Data-processing system 210 depicted in FIG. 2 can be, for example, a server. Other devices such as, for example, desktops, network devices, palmtops, mobile phones, etc may also be included in the network 235. The rendering devices 240, 242 and 244 can be located remotely with respect to each other, or alternatively, they can be located locally with respect to each other.

The rendering device can be, for example, an office machine, which incorporates the functionality of multiple devices in one, so as to provide centralized document management, document distribution and production in a large-office setting and the like. The typical rendering device may act as a combination of a printer, scanner, photocopier, fax and e-mail. While three rendering devices 240, 242 and 244 are shown by way of example, it is to be appreciated that any number of rendering devices can be linked to the network, such as two, four, six or more rendering devices. In general, the rendering devices 240, 242 and 244 can be employed to perform a rendering output function (e.g., printing, scanning, copying, faxing, etc) within a networked environment. Note that multifunction devices rendering devices are generally analogous to one another.

Historical data with respect to usage of each rendering device 240, 242 and 244 in the network 235 may be collected and stored on the database 285 accessible by the rendering devices 240, 242 and 244. The data may ideally be collected on a daily basis over preceding weeks (e.g., three weeks). A time out adjustment module 345 running within the network 235 can be adapted to monitor performance of the rendering devices 240, 242 and 244 and to optimize the power consumption during periods of inactivity. The time out adjustment module 345 detects an inactivity period (e.g., end of day use period) with respect to the rendering devices 240, 242 and 244. The time out adjustment module 345 may be also employed to minimize the impact on availability of the rendering devices 240, 242 and 244 (minimize wake up) if the end of day use varies from day to day.

Note that as utilized herein, the term “module” may refer to a physical hardware component and/or to a software module. In the computer programming arts, such a software “module” can be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module can be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as floppy disks, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

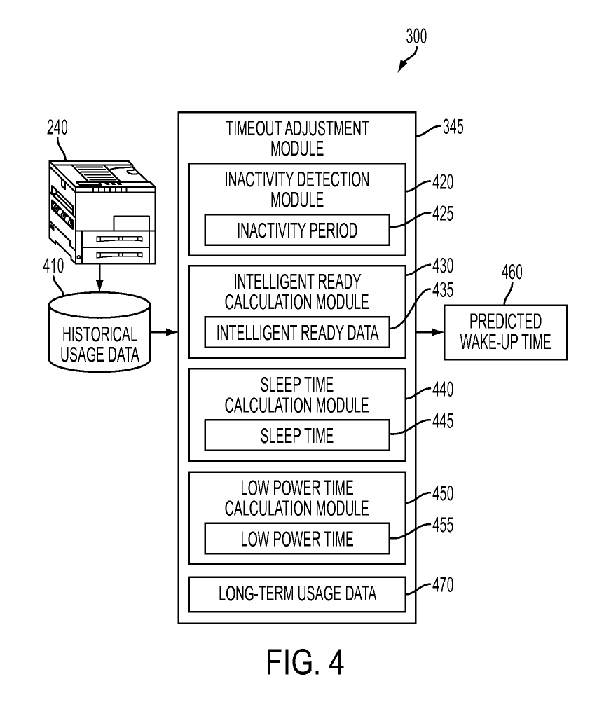

FIG. 4 illustrates a block diagram of the power reduction system 300 associated with the timeout adjustment module 345, in accordance with the disclosed embodiments. The power reduction system 300 generally includes the timeout adjustment module 345 that can be employed to maintain statistics on the customer usage patterns with respect to the rendering device 240. Historical usage data 410 with respect to usage of the rendering device 240 can be collected and stored in the database 285 coupled to the rendering device 240. The timeout adjustment module 345 further includes an inactivity detection module 420, an intelligent ready calculation module 430, a sleep time calculation module 440 and a low power time calculation module 450.

The inactivity detection module 420 can be adapted to detect an inactivity period 425 (e.g., end of day) and to intelligently force the device 240 into a sleep state by analyzing the historical usage data 410. The intelligent ready state calculation module 430 can be adapted to define an intelligent ready (IR) data 435 with respect to the rendering device 240 based on the inactivity period 425 and the historic data 410. The sleep time calculation module 440 and low power time calculation module 450 can be employed to calculate a sleep time 445 and a low power time 455 based on the periods of zero activity. A low power and sleep time out period can be reduced to a minimum value based on the inactivity period 425.

A long term usage 470 with respect to the rendering device 240 can also be calculated based on the historical data 410 in order to ensure that the device 240 is not in a low power state when usage is expected. The long term usage data 470 can be optimized to minimize the probability of a wake up time from the sleep and low power time 445 and 455. Thereafter, a sleep idle time value and a historic data weighting calculation can be modified in order to predict a wake-up time 460 before an activity is commenced with respect to the rendering device 240.

The historical usage data 410 can be tracked on a daily basis and the device 240 can be forced into the sleep state at the end of day and the impact on the rendering device 240 availability can be minimized if the end of day use varies from day to day. The long term usage can be tracked on daily basis over the preceding weeks (e.g., three weeks). The calculated sleep time 445 can identify a period where there has been no recent (yesterday) or long term (last three weeks) history of usage with respect to the rendering device 240. The time out adjustment module 345 can therefore effectively reduce the waiting time of the user with respect to the rendering device 240 with an optimized power-saving solution. The time out adjustment module 345 permits the device 240 to a low energy state sooner and then awakened prior to an expected activity in order to maximize the energy saving without causing customer dissatisfaction.

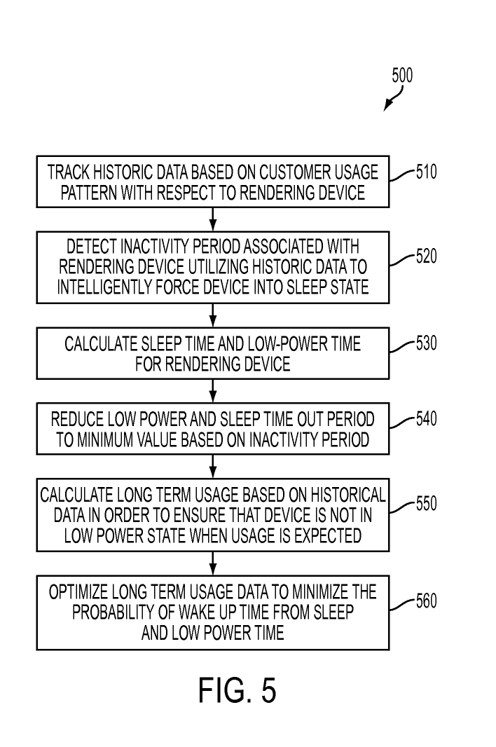

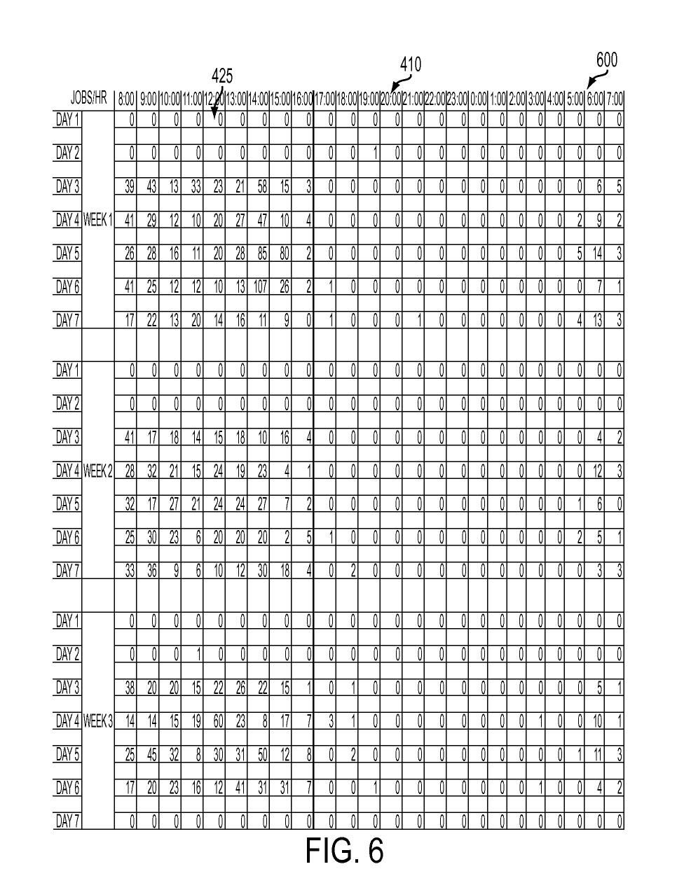

FIG. 5 illustrates a high level flow chart of operation illustrating logical operation steps of a method 500 for reducing power consumption based on an inactivity period in accordance with the disclosed embodiments. Again as a reminder, note that in FIGS. 2-7, identical or similar parts are generally indicated by identical reference numerals. The historical data 410 based on customer usage patterns associated with the rendering device 240 can be tracked, as depicted at block 510. The inactivity period 425 associated with rendering device 240 can be detected utilizing the historical data 410 to intelligently force the device 240 into sleep state, as illustrated at block 520. FIG. 6 illustrates a table 600 illustrating the historical data 410 and the inactivity period 425 associated with the rendering device 240, in accordance with the disclosed embodiments. The table 600 illustrates the historical data 410 and the inactivity period 425 for a period of three weeks.

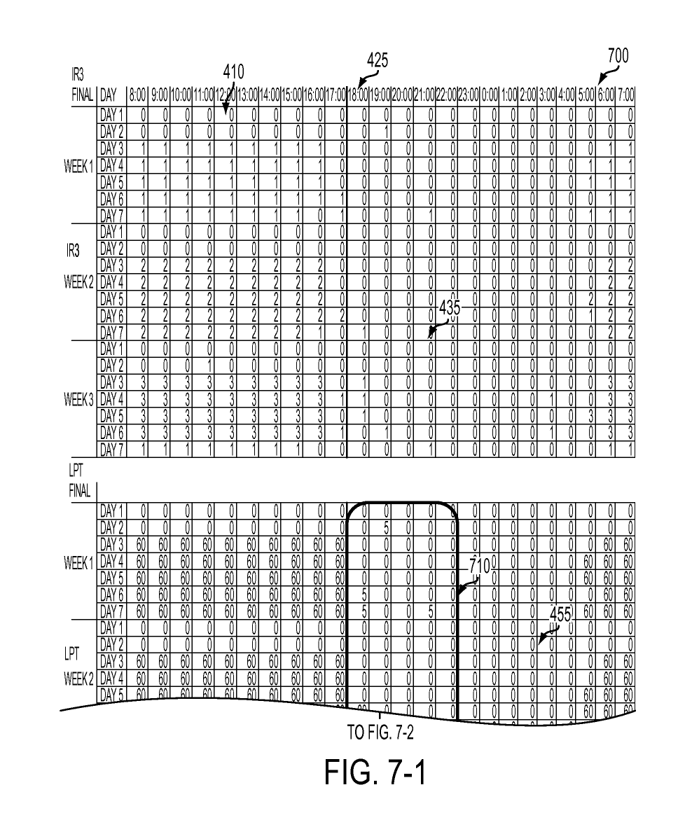

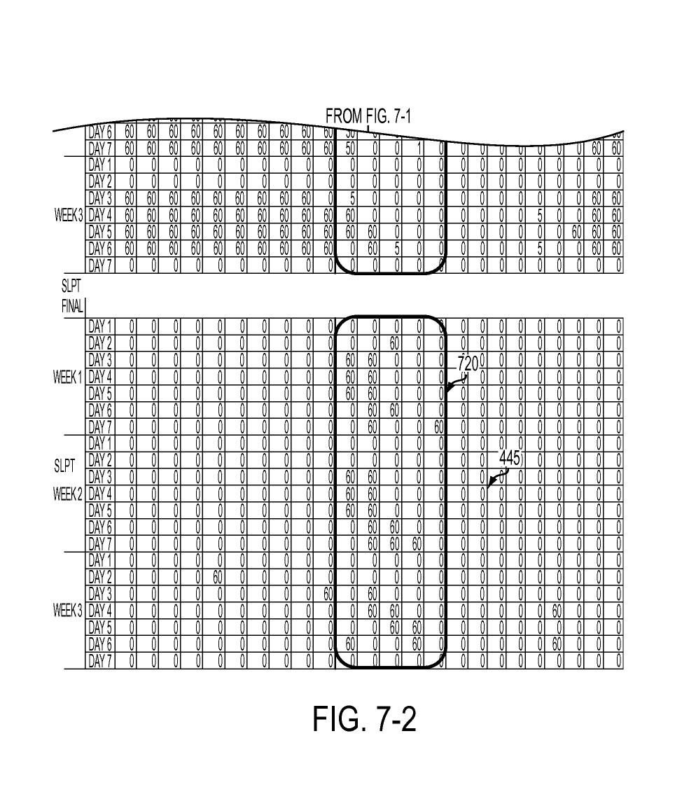

Thereafter, as illustrated at block 530, the sleep time and low power time 445 and 455 associated with the rendering device 240 can be calculated. FIG. 7 illustrates a table 700 illustrating an intelligent ready value 435, the low-power time value 455, and the sleep time value 445 associated with the rendering device 240, in accordance with the disclosed embodiments. The sleep time value 445 can be calculated based on the preceding day's history of “activity” either in the current or next hour as well as any historic usage for the same hour in the preceding three weeks. The sleep time 445 identifies a period where there has been no recent (e.g., yesterday) or long term (e.g., last three weeks) history of usage with respect to the rendering device 240.

Similarly, the low power time 455 can be calculated. The regions 710 and 720 associated with the low power time 455 and the sleep time 445 can represent the regions of potential power-saving with respect to the rendering device 240.

The low power and sleep time out period can be reduced to a minimum value based on the inactivity period, as indicated at block 540. A long term usage 470 with respect to the rendering device 240 can also be calculated based on the historical data 410 in order to ensure that the device 240 is not in a low power state when usage is expected, as depicted at block 550. Finally, as depicted at block 560, long-term usage data can be optimized to minimize the probability of a “wake up” time from a sleep state or low power state.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for reducing power consumption, said method comprising:
detecting an inactivity period by analyzing historical data based on a usage pattern associated with a device to intelligently force said device into a lower energy state;
calculating a sleep time and a low power time in order to thereafter reduce, respectively, a sleep time out period and a low power time out period, to minimum values based on said inactivity period, wherein said sleep time out period and said low power time period comprise transition periods; and
tracking a long term usage with respect to said device based on said historical data in order to thereafter optimize long term usage data to minimize a probability of said wake up time from said sleep time and said low power time, thereby reducing power consumption with respect to said device and minimize customer waiting time associated with said device.

2. The method of claim 1 further comprising modifying said sleep time based on said historical data to wake up said device when activity is predicted.

3. The method of claim 1 further comprising modifying said historical data weighting calculation in order to predict said wake up time with respect to an activity associated with said device.

4. The method of claim 1 further comprising collecting said historical data with respect to said usage pattern associated with said device in order to thereafter store said historical data in a database.

5. The method of claim 1 further comprising tracking said historical data associated with said device on a daily basis over a period of time.

6. The method of claim 1 further comprising directing said device to said sleep state with respect to said inactivity period.

7. The method of claim 1 further comprising resuming said device from said sleep state to an active state prior to an expected activity in order to maximize an energy saving without causing a customer dissatisfaction with respect to said device.

8. The method of claim 1 further comprising modifying a timeout algorithm associated with said device to enter and exit said sleep state to reduce power consumption.

9. The method of claim 1 wherein said inactivity period comprises an end of day usage period.

10. A system for reducing power consumption, said system comprising:
a processor;
a data bus coupled to said processor; and
a computer-usable medium embodying computer code, said computer-usable medium being coupled to said data bus, said computer program code comprising instructions executable by said processor and configured for:
detecting an inactivity period by analyzing historical data based on a usage pattern associated with a device to intelligently force said device into a lower energy state;
calculating a sleep time and a low power time in order to thereafter reduce, respectively, a sleep time out period and a low power time out period, to minimum values based on said inactivity period, wherein said sleep time out period and said low power time period comprise transition periods; and
tracking a long term usage with respect to said device based on said historical data in order to thereafter optimize long term usage data to minimize a probability of said wake up time from said sleep time and said low power time, thereby reducing power consumption with respect to said device and minimize customer waiting time associated with said device.

11. The system of claim 10 wherein said instructions are further configured for modifying said sleep time based on said historical data to wake up said device when activity is predicted.

12. The system of claim 10 wherein said instructions are further configured for modifying said historical data weighting calculation in order to predict said wake up time with respect to an activity associated with said device.

13. The system of claim 10 wherein said instructions are further configured for collecting said historical data with respect to said usage pattern associated with said device in order to thereafter store said historical data in a database.

14. The system of claim 10 wherein said instructions are further configured for tracking said historical data associated with said device on a daily basis over a period of time.

15. The system of claim 10 wherein said instructions are further configured for directing said device to said sleep state with respect to said inactivity period.

16. The system of claim 10 wherein said instructions are further configured for resuming said device from said sleep state to an active state prior to an expected activity in order to maximize an energy saving without causing a customer dissatisfaction with respect to said device.

17. The system of claim 10 wherein said instructions are further configured for modifying a timeout algorithm associated with said device to enter and exit said sleep state to reduce power consumption.

18. The system of claim 10 wherein said inactivity period comprises an end of day usage period.

19. A system for reducing power consumption, said system comprising:
a processor;
a data bus coupled to said processor; and
a computer-usable medium embodying computer code, said computer-usable medium being coupled to said data bus, said computer program code comprising instructions executable by said processor and configured for:
detecting an inactivity period by analyzing historical data based on a usage pattern associated with a device to intelligently force said device into a lower energy state;
calculating a sleep time and a low power time in order to thereafter reduce, respectively, a sleep time out period and a low power time out period, to minimum values based on said inactivity period, wherein said sleep time out period and said low power time period comprise transition periods;
tracking a long term usage with respect to said device based on said historical data in order to thereafter optimize long term usage data to minimize a probability of said wake up time from said sleep time and said low power time;
modifying said sleep time based on said historical data to wake up said device when activity is predicted; and
configuring said historical data weighting calculation in order to predict said wake up time with respect to an activity associated with said device, thereby reducing power consumption with respect to said device and minimize customer waiting time associated with said device.

20. The system of claim 19 wherein said instructions are further configured for modifying a timeout algorithm associated with said device to enter and exit said sleep state to reduce power consumption.
